(19) United States
(12) Patent Application Publication
(10) Pub. No.: US 2007/0198280 A1
(43) Pub. Date: Aug. 23, 2007

(54) Device, method and system for creating, framing, transporting, displaying, and selling artwork

(76) Inventors: Paul E. Noble, Cumming, GA (US); R. Steven Bostic, Sea Island, GA (US)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/358,602

(22) Filed: Feb. 21, 2006

(51) Int. Cl. G06Q 99/00

(52) U.S. Cl. 705/1

(57) ABSTRACT

A device, method and system for creating, framing, transporting, displaying, and selling artwork. The method generally includes the steps of supplying a specialized sheet of paper to an individual or a group of individuals wherein the sheet includes an identified area for receiving artwork produced by an individual or a group; having the individual or group of individuals produce artwork in the identified area for receiving artwork provided on the sheet of paper; marking the sheet of paper with information related to the identification of the individual or group of individuals; framing the sheet of paper in a frame; hanging the framed sheet of paper on a portable device for displaying and transporting a plurality of framed artists panel; and displaying a plurality of framed artists panel to a viewer or a group of viewers at an art show, for example. The device for displaying and transporting artwork generally includes a portable device for displaying a plurality of framed media and a method for displaying framed media so that multiple pieces of media may be displayed simultaneously. The method for framing artwork generally includes the steps of providing a pre-sized artists panel having artwork on an artwork area and identifying information about the artist on an information area separate from the artwork area; providing a pre-sized combination of framing elements including a frame, a transparent glazing, a mat, a backing board, and a hanger; and mounting the artwork within the frame, and the pre-sized artists panels are sized to cooperate with the framing elements so as to allow the efficient and economical framing of artwork.

### BACKGROUND OF THE INVENTION

1. Technical Field

The present invention relates generally to devices, methods and systems of creating, framing, displaying, and selling artwork. The present invention relates more specifically to an overall system for creating artwork on a piece or sheet of art paper or canvas or other substrate, framing the artwork using a framing method, digitally photographing the artwork into a digital database and allowing the artwork to be viewed over a computer network, displaying the artwork on a display structure, and offering the artwork for sale. The present invention also relates more specifically to a business method for selling artwork and for fundraising by organizations by selling artwork. The present invention further relates more specifically to a collapsible and transportable display structure for displaying a plurality of pieces of artwork and to a plurality of such display structures that can be transported as a unit. The present invention additionally relates more specifically to a framing method that incorporates framing a uniform artist's substrate in a uniform framing package using uniform framing components.

2. Prior Art

Devices, methods and systems for creating, framing, displaying and selling works of art have taken a wide variety of forms. Traditionally, artwork is created in a medium, framed in a frame, and displayed in a manner selected by the artist or the patron. Similarly, artwork is sold in many traditional settings, including galleries and art shows. For example, paintings and the like typically are painted on a canvas or paper of a size selected by the artist and then framed using framing materials chosen by the artist. The artwork, whether framed or not, can be displayed for sale by hanging on a wall or on structures specifically created for displaying artwork. Often this practice is limiting in that the walls and display structures, and thus the framed works individually or as a group, are not portable. Moreover, there may be insufficient wall space for a large display of multiple works of art.

Traveling art shows often involve complex and time consuming set-up and take-down. The artwork typically must be individually wrapped for protection, boxed or crated for transportation, loaded into a transport vehicle and transported to the art show site, unloaded and unboxed or uncrated, and hung on a wall or display structure. After the show, this process must be reversed for the unsold art.

As a specific example of the complexities and inefficiencies of art shows is an art show put on by a school or the like. Often, a class of students, or an entire grade or school, will want to create and display artwork for the rest of the school or for an art show for the benefit of the parents or a school fund-raising auction. Currently, such shows often involve students creating artwork and the artwork being taped or otherwise attached to the gymnasium wall for viewing by the parents. If the artwork is sold, preferably to the artists' parents, it merely is removed from the wall and taken home. As can be seen, there often is no rhyme or reason to such shows except to hang, show and sell as much of the students' artwork as possible.

Along the same vein, schools always seem to be in need of additional funding and often have activities for raising money. Such activities include wrapping paper sales, bake sales, fall festivals, and auctions at which parents can purchase a myriad of items and services, the proceeds of which benefit the school. Many times, such auctions included the sale of original artwork produced by the students. However, the artwork selected for the sale may be selected haphazardly and may not include artwork from each student. Further, the artwork likely is displayed haphazardly.

Thus, it can be seen that a need exists for creating, framing, transporting, displaying, and selling framed artwork in a uniform and efficient manner. It also can be seen that a need exists for a device for easily displaying and transporting artwork to and from art shows. It further can be seen that a need exists for uniformly framing artwork. It additionally can be seen that a need exists for a device, method and system for portably displaying multiple pieces of similarly sized, framed works of art as a collection so that a collection of similarly sized, framed works of art can be transported and displayed at multiple locations to provide a traveling exhibition. Further, it can be seen that a need exists for a manner for parents and other people to be able to inexpensively and easily purchase framed artwork, such as artwork produced by their children or other relatives. It is to these needs and others that the present invention is directed.

### BRIEF SUMMARY OF THE INVENTION

Briefly, the present invention is a device, method and system for creating, framing, transporting, displaying, and selling framed artwork. In one embodiment, the method generally includes the steps of: (1) supplying a specialized sheet of paper to an individual or a group of individuals wherein the sheet includes an identified area for receiving artwork produced by an individual or a group; (2) having the individual or group of individuals produce artwork in the identified area for receiving artwork provided on the sheet of paper; (3) marking the sheet of paper, preferably outside of the identified area for receiving artwork, with information related to the identification of the individual or group of individuals; (4) framing the sheet of paper now comprising the artwork using framing components, comprising one or more of a backing sheet, a mat or combination of mats, glazing, a frame, and a hanging means; (5) hanging the framed sheet of paper on a portable device, namely one or more panels, for displaying and transporting a plurality of framed sheets of paper; and (6) displaying a plurality of framed sheets of paper on one or more panels, preferably a plurality of panels holding twelve or more pieces of framed artwork, to a viewer or a group of viewers at an art show, for example. The number and order of the steps can vary, and there can be additional steps as well. For example, the sheet of paper can be marked with an individual's identification information before or after the individual produces artwork. Additionally, the artwork can be offered for sale and any unsold artwork unframed and returned to the artist, with the potential that the removed framing components can be reused. Further, the artwork can be digitally photographed for electronically viewing and reproducing.

As used herein, the term sheet of paper includes, but is not limited to, any surface upon which artwork can be produced and then framed such as paper, canvas, sheets, fabric, linen, cardboard, synthetic surfaces and so forth. The preferred frame has overall outer dimensions of approximately 18 inches wide by approximately 15 inches high. Such frame dimensions result in inside dimensions of approximately 16 inches by approximately 13-⅛ inches for receiving the backing, the artwork, the mat and the glazing. Preferably, the sheet of paper has dimensions of approximately 15-⅞ inches by approximately 13 inches. The backing, the mat and the glazing preferably have the same outside dimensions as the sheet of paper, which in the preferred embodiment are approximately 15-⅞ inches by approximately 13 inches. Of course, the paper size, artwork area size and frame size can be varied as desired.

The sheet of paper also preferably comprises an interior area that includes an identified area for receiving artwork that is approximately 10-⅞ inches wide by approximately 8 inches high, leaving about 2 inches of border around each edge that can be covered by a mat during framing. The interior area identified for receiving artwork provides a template for the artist to create art and to focus his or her artistic expression. The area identified for receiving artwork may be designated or set off by lines, shading or other markings from one or more areas for receiving information related to identification of the individual producing the artwork and where the individual is located, so that the artwork can be associated with the artist, location, teacher, class or school, for example. The area for receiving information related to identification can be on the front or back surface of the sheet of paper, but preferably is on the front surface and not within the area for receiving artwork. The sheet of paper may include a bar code or radio frequency identification (RFID) with this information and/or to provide for identifying and tracking of the artwork.

In a preferred embodiment of the overall system, the sheets of paper are supplied by a supplier to group of artists, such as, for example purposes but not limited to, a school class as part of a class project and/or fund-raising event. Other illustrative groups can include boy and girl scout troops, boys and girls clubs, team building seminar groups, after school classes such as religious schools and stay and play classes, and other schools and groups of people. Alternatively, the school or the students may supply their own sheets of paper. The sheets of paper are distributed to the students so that the students can produce a work of art. The finished works of art then are returned to the supplier so that the supplier can frame the artwork. Alternatively, the framing components can be supplied to the school (or whatever group or individual is creating the artwork) such that the artwork may be framed by the artists themselves, or by the school or other group utilizing the invention. The artwork also can be digitally scanned or preferably photographed or photocopied, preferably digitally, so that an image of the artwork can be viewed by the student, the student's parents and other individuals, and electronically reproduced.

In a preferred embodiment, prior to framing, the sheet of paper is digitally photographed to capture an image of the artwork produced by the artist. The digitally photographed image then may be stored on a computer system, network, internet, CD-ROM and so forth so that individuals may retrieve and view the image. In a preferred embodiment, before or after digitally photographing and creating a digital reproduction of the artwork, an access code is assigned to each piece of artwork so that an individual can identify and view the artwork over the internet by using the access code. Written material, such as a pamphlet, with information about the website, services, prices for framing, copies and so forth may be provided to the student so that the students can take information home with them to their parents. In addition, an access code assigned to the student artist or a group of student artists also may be included with the written information.

Typically, the work of art is framed using the present invention's method for framing artwork in a specialized picture frame using specialized framing components and a specialized framing process. For example, the framing process may include placing and arranging the preferred specialized sheet or paper on a pre-sized backing material, then arranging and placing a pre-sized mat over the sheet of paper. Preferably, the sheets of paper, the backing boards, and the mats are similarly sized (all having the same outer dimensions of approximately 15-⅞ inches by approximately 13 inches in the preferred embodiment, and all having the same outer dimensions as each other for embodiments of different sized artwork) to simplify framing. The mat preferably has an opening that is sized and shaped to correspond to the identified area for receiving artwork (approximately 10-⅞ inches by approximately 8 inches for the preferred embodiment, and other sizes for other embodiments) and covers any marks outside of the identified area for receiving artwork that identify this area and the area for receiving information. The matted sheet of paper also is preferably covered by a sheet of glass, clear plastic such as acrylic or PLEXIGLAS( polymer, LEXAN® polycarbonate resin, and other clear materials suitable for use in framing, and then framed in an appropriately pre-sized and shaped frame. The frame also preferably includes a device from which the framed picture can be hung on a wall and/or the display panel of this invention.

The framed artwork then is hung on the present invention's device for displaying and transporting artwork, transported to a desired location, and displayed for viewing and for sale. A specialized gallery tag can be created and associated with the framed artwork. The gallery tag preferably comprises information about the artist gleaned from the information supplied by the artist and the school, generally as written onto the area for receiving information on the art template, is printed on cardstock, and is associated with the respective piece of framed artwork to help in making a more complete and professional presentation of the framed artwork, imitating an art gallery in which information about the artwork and the artists is contained on a plaque mounted on the wall next to the artwork.

Framed artwork that is sold can be taken by the purchaser. Individuals, for example the student artist's parents, may purchase the framed original artwork from the supplier, preferably after an image of the original artwork has been digitally photographed and stored in some electronically retrievable form. Copies of the original also may be purchased either framed or unframed. Framed artwork that needs to be shipped to the purchaser is placed in a specialized shipping box created for the invention, which is of a size and configuration to contain and protect the framed artwork during shipping. Unsold framed artwork is transported back to a disassembling location, at which the artwork is removed from the frame, the artwork is returned to the artist, and the frame is reused. The fee charged for the framed artwork can be retained by the supplier, retained by the school or other institution, or split among various parties including a school or other institution and the supplier.

The present invention also provides a device for displaying and transporting artwork comprising a portable device for displaying a plurality of framed media and a method for displaying framed media so that multiple pieces of media may be displayed simultaneously. The framed media may be or include, for example, photographs, drawings, posters, sketches, works of art such as watercolors or pastels, album covers, framed mementos and so forth. In a preferred embodiment, the framed media is or includes framed drawings, colorings, paintings and other works of art, as framed using the system disclosed herein. The display of multiple pieces of artwork or media is desirable in certain circumstances such as art shows and/or fund raising events.

In one embodiment the portable device includes at least one panel, and preferably at least two panels that are hingedly attached to each other. Each panel includes a framework that is formed from vertical members and horizontal members. More specifically, each panel preferably is formed from a lower horizontal member that is connected to a first vertical member at a first end of the lower horizontal member and a first end of the first vertical member. The other end of the first vertical member is connected to one end of an upper horizontal member. The other end of the upper horizontal member is connected to one end of a second vertical member. The other end of the second vertical member is connected to the second end of the lower horizontal member to form a rectangular framework.

The panel further includes one or more intermediate horizontal members that include means for hanging or otherwise attaching framed pictures to one of the horizontal members. Additional vertical members also can be included for greater structural stability and/or aesthetics. The combination of horizontal and vertical members forms a grid work having openings of approximately the size of, and generally slightly larger than, the framed artwork. The means for hanging the artwork include, but are not limited to, channels, clips, cables, hooks, strips, slots, holes, wires, and so forth that are capable of receiving framed pictures. The framed pictures may include sawtooth hangers, wires and eyelets, hooks or other hanging devices on the backs or the tops of the frames so that the hook or hooks can be inserted into the cables, strips, slots, or holes provided on the horizontal members. Preferably, the frame comprises a sawtooth hanger centered on the upper horizontal frame element.

In certain embodiments, strips, wires or the like are extended between vertical members at appropriate heights for hanging the artwork such that the artwork hangs within the grid work formed by the vertical and horizontal members. The artwork then can be hung directly on the strips, wires or the like. In other embodiments, the horizontal members can include hooks or nails or other means or devices for hanging that are adapted to receive hooks, wires or saw tooth hangers that are or can be provided on the backs of the picture frames. Alternatively, slots or holes can be provided in the horizontal members of the panel so that one end of an S-hook or other hanging device can be inserted in the holes or slots and the other end used to suspend a framed picture from a sawtooth hanger that can be provided on the back of a picture frame.

In the preferred embodiment, strips of aluminum or other relatively rigid material extend horizontally across the panels at selected heights to form mounting strips. The framed artwork is hung on the mounting strips using broadened S-shaped hooks. More specifically, a hook having an S-shaped cross-section and being approximately as wide as the sawtooth hanger attached to the frame is used to hang the framed artwork on the mounting strip, and thus mount the framed artwork on the panel. The S-hook may itself hang from the mounting strip, but preferably is securely attached to the mounting strip using pop rivets or the like to reduce the chance the S-hook will rock relative to, or fall off of, the mounting strip. It has been found that the use of this specialized hook to mount the framed artwork on mounting strips that are approximately 1 inch tall by ¼ inch thick provides a suitably secure mounting system, and helps prevent the framed artwork from rocking back and forth during transport. Merely hanging the framed artwork using wires and conventional hooks, nails and sawtooth hangers, or other single pivot mechanisms, could allow the framed artwork to rock during transport, which could be detrimental to the framed artwork.

The preferred shape of the framework for the panels is rectangular, based on the preferred shape of the frames. The primary horizontal and vertical panel framework members, that is the uppermost and lowermost horizontal members and the outermost vertical members, can be formed from many rigid materials, preferably materials that are light in weight but that are rigid enough and strong enough to support the weight of the media that the device is intended to transport and display. In preferred embodiments, the framework is formed from horizontal and vertical members of square aluminum tubing that are welded, bolted or otherwise joined to one another to form a framework. A suggested size for square aluminum tubing that could be used to form the framework of a panel is about one and a half inches square. However, other shapes, such as circular tubes and angles, and other dimensions as well as other tubing materials such as plastic composites, carbon composites, ceramics and ceramic composites, steel and titanium can be used. The intermediate horizontal members preferably are the mounting strips. Although intermediate vertical members are possible, their need is minimal.

A backing material preferably is attached to the panel on the panel side opposite where the framed artwork is mounted. The backing material has approximately the same outer dimensions as the panels such that when attached to the panels, the backing material completely or substantially completely fills the opening between the uppermost and lowermost horizontal members and the outermost vertical members. The backing material provides a backdrop for the framed artwork such that a viewer cannot see between neighboring pieces of framed artwork when mounted on the panels, and therefore cannot see through the panels. The preferred backing material has a photo gray color as it has been found that such a color is the best way to show framing that contains only black (the frame) and white (the mat), as gray is a blend between the two neutral colors of black and white. The backing material can be attached to the panels by any known and future developed means, such as VELCRO® hook and loop material, clips, rivets, adhesives, and the like. It is preferred that the backing material be removably mounted for cleaning and replacing with a different color material, if desired.

The size of each panel and opening can be varied. In preferred embodiments, the panels are of a size that can be rolled through a typical door opening of approximately 6 feet 8 inches high and can carry 12 pieces of framed artwork in a three across (row) by four high (column) array. One suggested size for a row (that is, the vertical distance between neighboring mounting strips or between the lowermost mounting strip and the lowermost horizontal member) is approximately 16 inches high, and preferably approximately 15-¾ inches high, so that four rows can be provided vertically in a panel and the panel still would fit through a typical door opening. Thus, including the additional height of the horizontal members and any casters to move the panels, the preferred panels are approximately 72 inches high and approximately 64 inches wide. Although it is preferred to maintain the panel height at less than 80 inches so that the panels can fit through the vast majority of door frames, the width of the panels can be varied depending on the selected array of framed artwork to be mounted. For example, a single-column panel could be on the order of approximately 18 inches wide, while a five-column panel would be closer to approximately 90 inches wide. As the panels themselves are on the order of 1-½ inches thick, and the framed artwork mounted on the panels is mounted within the footprint of the panels and therefore does not add any thickness, a hinged pair of panels would be approximately 3 to 4 inches thick, and a set of 8 pairs of hinged panels preferably would be no more than approximately 24 to 32 inches thick, approximately 72 inches tall, and approximately 5 to 5-½ feet wide (long), which can be rolled, moved and maneuvered into and out of a truck, through typical doors, and along typical hallways by two typical people.

In one preferred embodiment, two similar panels are attached to each other at one vertical end of each of the panels with a hinge so that the two panels can be folded together for storage and transportation to another location. At a location, the pair of panels can be unfolded into an angular configuration for display purposes, with the angle between the panels allowing the pair of panels to be free-standing. For example, four such pairs of panels may each be unfolded at 90° angles and then arranged in back-to-back orientations to provide a cross- or X-shaped display of the four panels that allows the display of multiple pieces of framed artwork in a limited amount of space. Alternatively, multiple panels can be arranged in a zigzag pattern to provide a display suited for a longer area such as a hallway. It should be noted that the panels are portable and can be arranged in a wide variety of other patterns and various sizes of displays. In certain preferred embodiments, the panels also can include means for rolling or moving the panel or a pair or more of the panels across a floor. Additionally, if the panels have framed artwork hanging from the panels, a layer of foam material or other protective material can be inserted between folded panels to protect the framed artwork. In such a situation, it can be preferable for the artwork on each panel to face inwards relative to the folded panels, such that the protective material protects the fronts of the framed artwork.

As disclosed above, four or more pairs of panels can be stacked together vertically to from a brick that can moved as a single unit and desirably should fit through a typical door opening. Custom sized pad covers, preferably made of moving pad material, can be attached to each pair of panels to protect at least the outwardly facing sides of the panels. A brick of panels can be covered with an envelope of material, preferably a flexible yet strong material, to protect the panels and any wall or door frame that the panels may come into contact with while moving the panels, and to help to keep the four pairs of panels together as the brick.

A brick of panels also can be bound together for storage and transportation with a strap or other means of securing the panels together. As such, an exhibit of greater than 1150 pieces of framed artwork can be provided with six bricks of panels, with each brick made up of eight pairs of panels and each panel including 12 framed pieces of artwork, yet the entire collection would take up a volume of only about 6 feet by 7 feet by 18 feet. It is envisioned that two people would be able to unload and set up such a 1150-piece art exhibit in a short amount of time, preferably under an hour.

The present invention further provides a method for framing artwork comprising the steps of providing a pre-sized artists panel having artwork on an artwork area and identifying information about the artist on an information area separate from the artwork area; providing a pre-sized combination of framing elements including a frame, a transparent glazing, a mat or combination of mats, a backing board, and a hanger; and mounting the artwork within the frame. The pre-sized artists panels are sized to cooperate with the framing elements so as to allow the efficient and economical framing of artwork.

For example, the method for framing artwork may include, after the artwork has been created on the preferred specialized artists panel (this term will be used herein as a general term for any paper, sheet, canvas, board, etcetera, that can be used as the substrate for the artwork), placing and arranging the artists panel on a pre-sized backing material, then arranging and placing a pre-sized mat over the artists panel. Preferably, the artists panels, the backing boards, and the mats are similarly sized (all having the same outer dimensions of approximately 15-⅞ inches by approximately 13 inches in the preferred embodiment, and all having the same outer dimensions as each other for embodiments of different sized artwork) to simplify framing. The mat preferably has an opening that is sized and shaped to correspond to the identified area for receiving artwork (approximately 10-⅞ inches by approximately 8 inches for the preferred embodiment, and other sizes for other embodiments) and covers any marks outside of the identified area for receiving artwork that identify this area and the area for receiving information. The matted sheet of paper also is preferably covered by a sheet of glass, clear plastic such as acrylic or PLEXIGLAS® polymer, LEXAN® polycarbonate resin, and other clear materials suitable for use in framing, and then framed in an appropriately pre-sized and shaped frame. The frame also preferably includes a device from which the framed picture can be hung on a wall and/or the display panel of this invention. The method also can include an optional step of removing the artwork from the frame such that the artwork can be returned to the artist unframed and/or the frame can be reused with other artwork.

These features, and other features and advantages, of the present invention will become more apparent to those of ordinary skill in the relevant art when the following detailed description of the preferred embodiments is read in conjunction with the appended figures in which like reference numerals designate like elements throughout the several views.

### BRIEF DESCRIPTION OF THE DRAWINGS

A full and enabling disclosure of the present invention, including the best mode thereof, is set forth in the detailed description of the preferred embodiments, which makes reference to the appended figures in which:

FIG. 1 is a front view of a preferred device embodying the invention.

FIG. 2 is a front view of a second preferred device including an attached second device shown in side view.

FIG. 3 is a top view of the pair of panels of FIG. 2 in an open, display configuration.

FIG. 4 is a top view of the pair of panels of FIG. 2 in a partially collapsed position.

FIG. 5 is a top view of the pair of panels of FIG. 2 in a fully collapsed position.

FIG. 6 is a top view of several pairs of panels that have been arranged in fully collapsed positions.

FIG. 7 is a top view of four pairs of panels arranged in an X-shaped display configuration.

FIG. 8 is a perspective view of four pairs of panels arranged in an X-shaped display configuration for exhibition purposes.

FIG. 9 is a top view of four pairs of panels arranged in a zigzag display configuration.

FIG. 10 is a front view of a representative artists panel of the invention.

FIG. 11 is a front view of the representative artists panel shown in FIG. 10 and having artwork thereon.

FIG. 12 is a perspective view of a representative S-hook used to mount framed artwork on panel mounting strips.

FIG. 13 is a front view of a representative backing panel suitable for use with the present invention.

FIG. 14 is a perspective view of three panel pairs showing the use of backing panels and panel pad covers.

FIG. 15 is a perspective view of a panel pair showing the placement of a panel pad.

FIG. 16 is a front view of a brick of panels covered by a protective envelope.

FIG. 17 is an exploded assembly view in perspective of the framing components of the present invention.

FIG. 18 is a flow chart of a representative system for creating, framing, displaying and selling artwork of the present invention.

FIG. 19 is a flow chart of a representative method for framing artwork of the present invention.

FIG. 20 is a flow chart of a representative method for tracking an exemplary access code used in the present invention.

FIG. 21 is a mock-up of an exemplary gallery tag suitable for the present invention including an access code.

### DETAILED DESCRIPTION OF PREFERRED EMBODIMENTS

The present invention provides a system, methods, and a device for creating, framing, transporting, displaying, and selling artwork. The system can be the basis for a business method for selling artwork for profit and for fund raising purposes, among other purposes. The methods can be for creating displayable artwork from conception to sale of an original piece of art, safely and securely transporting and displaying artwork, and framing artwork. The device can be for transporting and displaying artwork.

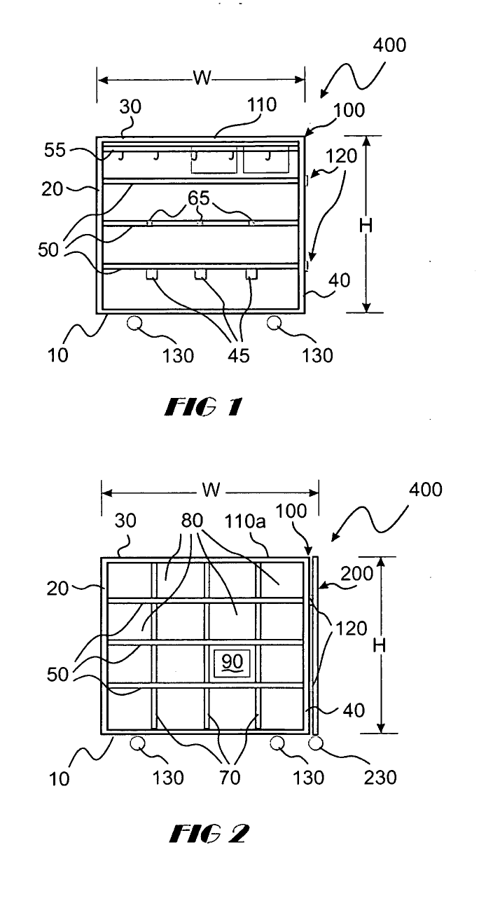

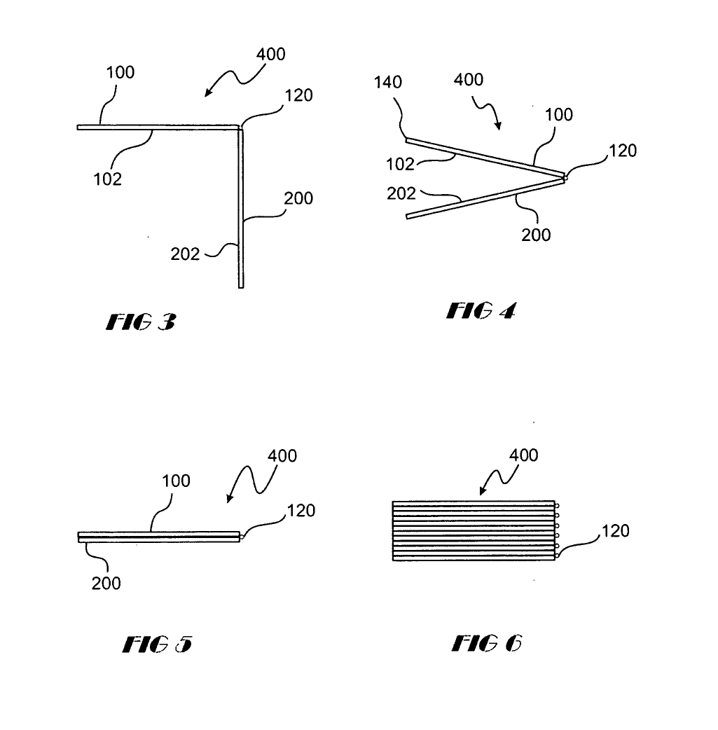

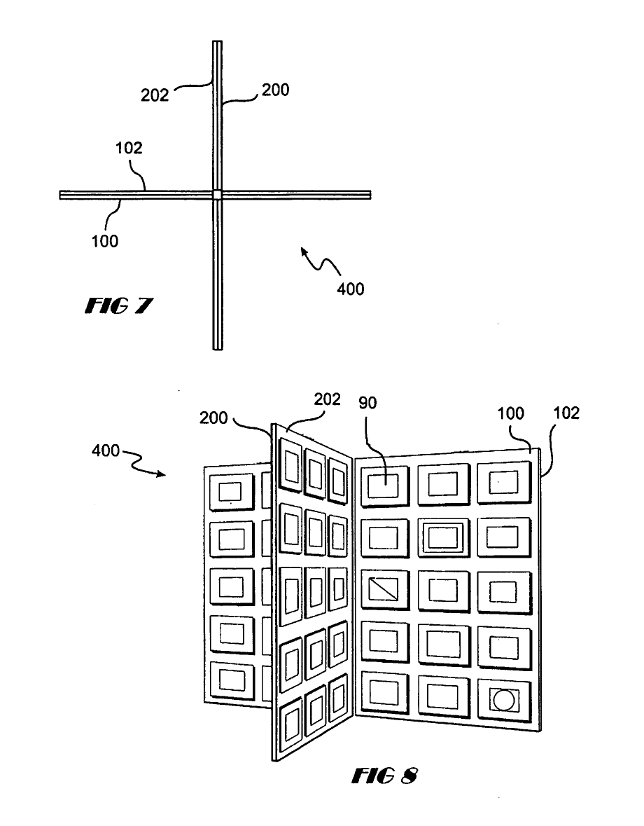

Reference to the appended figures will assist in understanding the invention. FIGS. 1-6 show preferred views of a device for transporting and displaying artwork. FIG. 1 is a front view of a preferred device for transporting and displaying the artwork created using the systems and methods of the present invention. FIG. 2 is a front view of a second preferred device transporting and displaying the artwork including two panels for transporting and displaying artwork shown in side view. FIG. 3 is a top view of the pair of panels of FIG. 2 shown in an open, display configuration. FIG. 4 is a top view of the pair of panels of FIG. 2 shown in a partially collapsed position. FIG. 5 is a top view of the pair of panels of FIG. 2 shown in a fully collapsed position. FIG. 6 is a top view of several pairs of panels that have been arranged in fully collapsed positions.

FIGS. 7-9 show preferred views of the devices for transporting and displaying artwork in display configurations. FIG. 7 is a top view of four pairs of panels arranged in an X-shaped display configuration. FIG. 8 is a perspective view of four pairs of panels arranged in an X-shaped display configuration for exhibition purposes. FIG. 9 is a top view of four pairs of panels arranged in an zigzag display configuration.

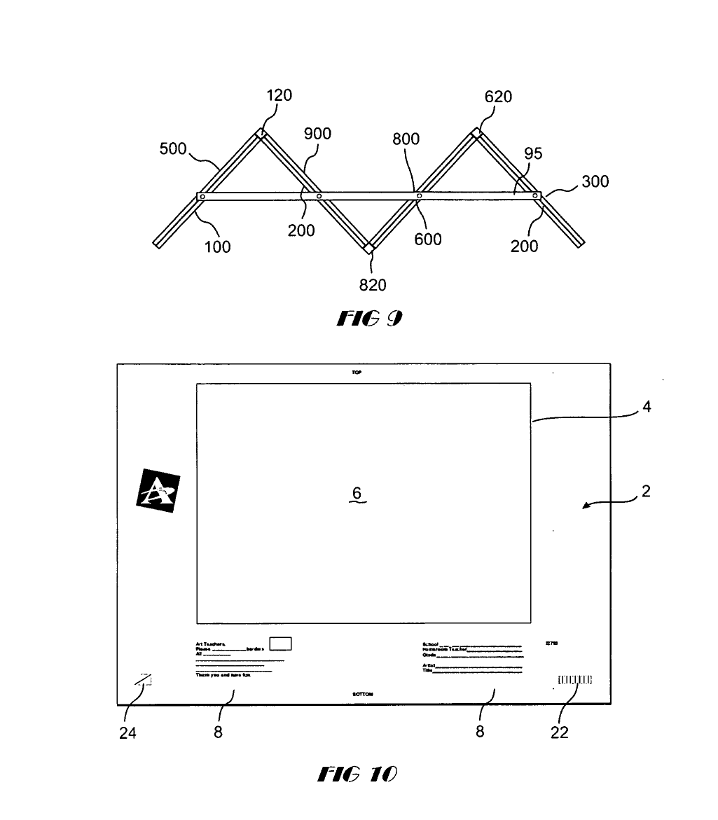

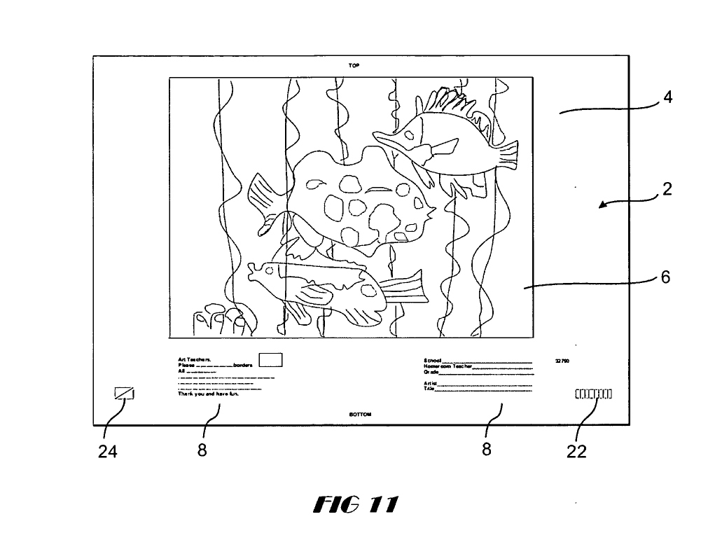

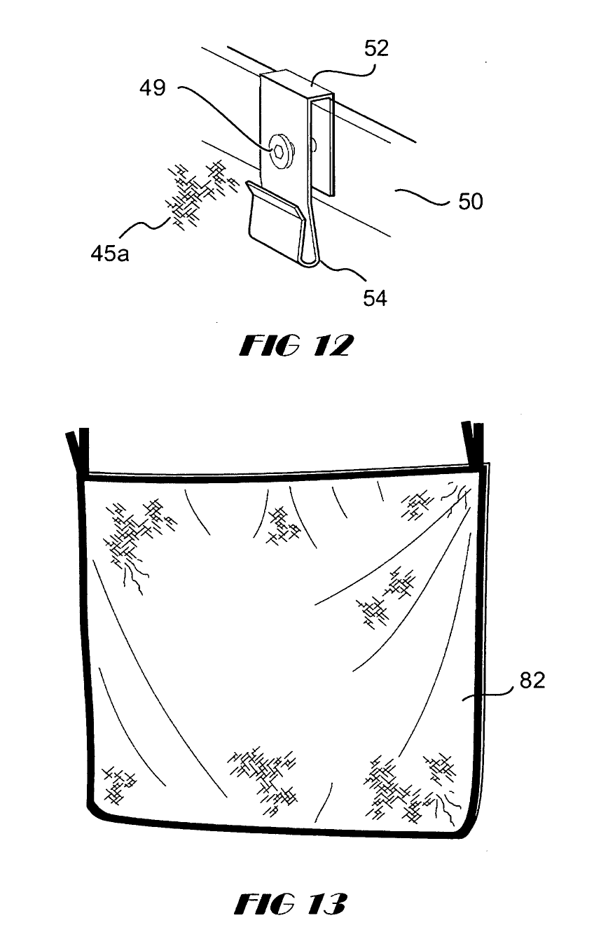

FIG. 10 is a front view of a representative artists panel of the invention schematically illustrating the relative placement of the various elements of the artists panel. FIG. 11 is a front view of the representative artists panel shown in FIG. 10 and having artwork thereon. FIG. 12 is a perspective view of a representative S-hook used to mount framed artwork on panel mounting strips illustrated as being riveted to a horizontal mounting strip.

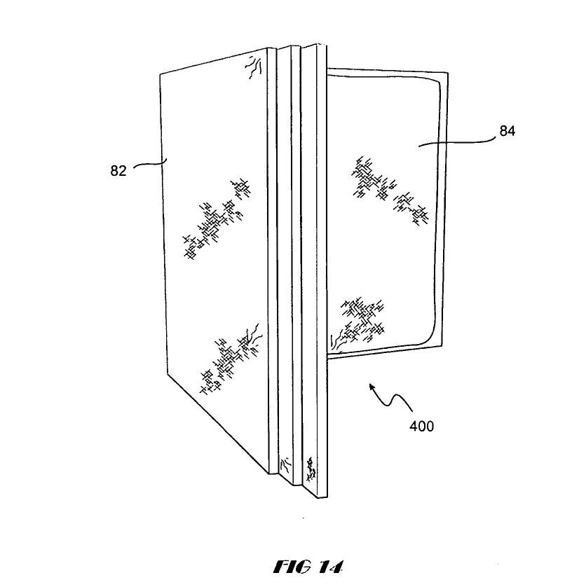

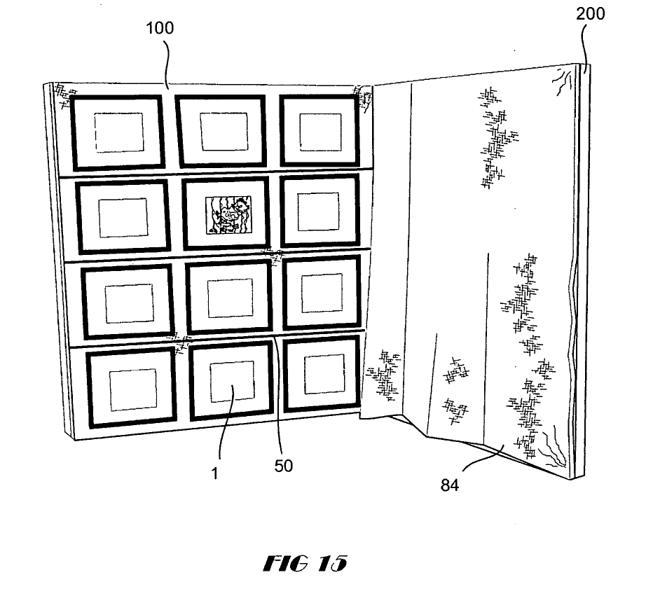

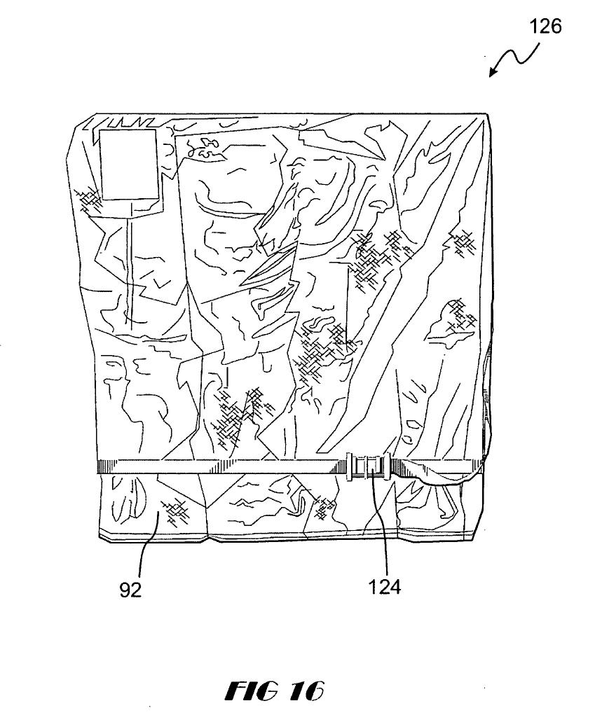

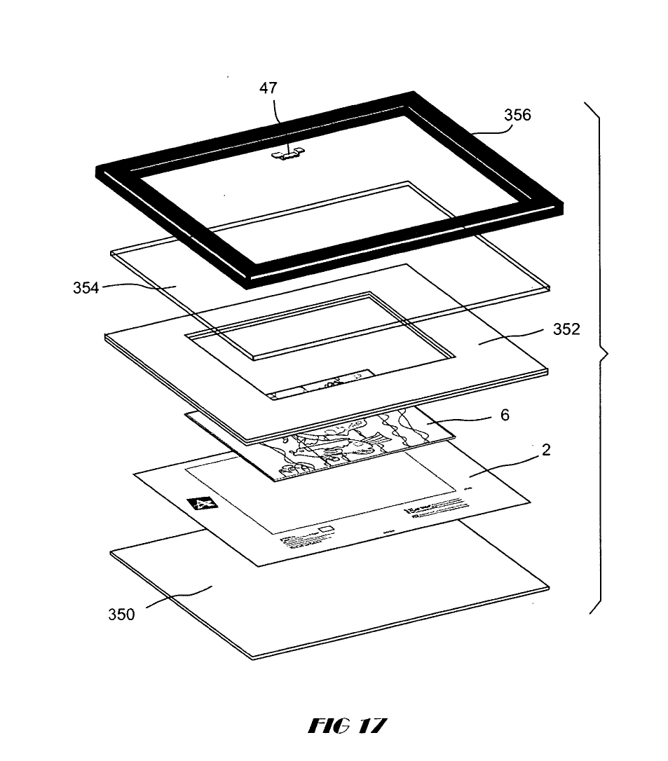

FIG. 13 is a front view of a representative backing panel suitable for use with the present invention shown apart from the panels. FIG. 14 is a perspective view of three panel pairs showing the use of backing panels attached to the back of the panels and panel pad covers hanging over the front of the panels. FIG. 15 is a perspective view of a panel pair showing the placement of a panel pad. FIG. 16 is a front view of a brick of panels covered by a protective envelope of material for storage and transport. FIG. 17 is an exploded assembly view in perspective of the framing components of the present invention showing the order of assembly of the preferred frame.

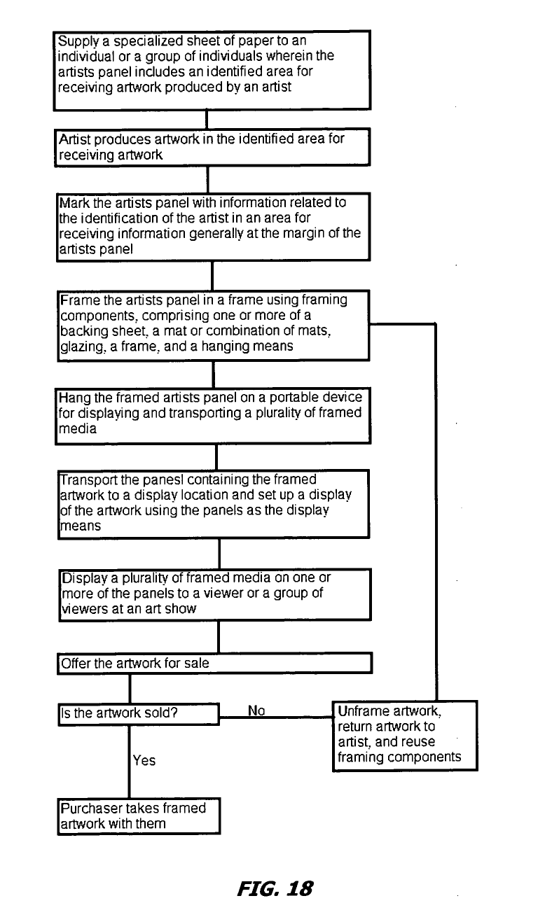

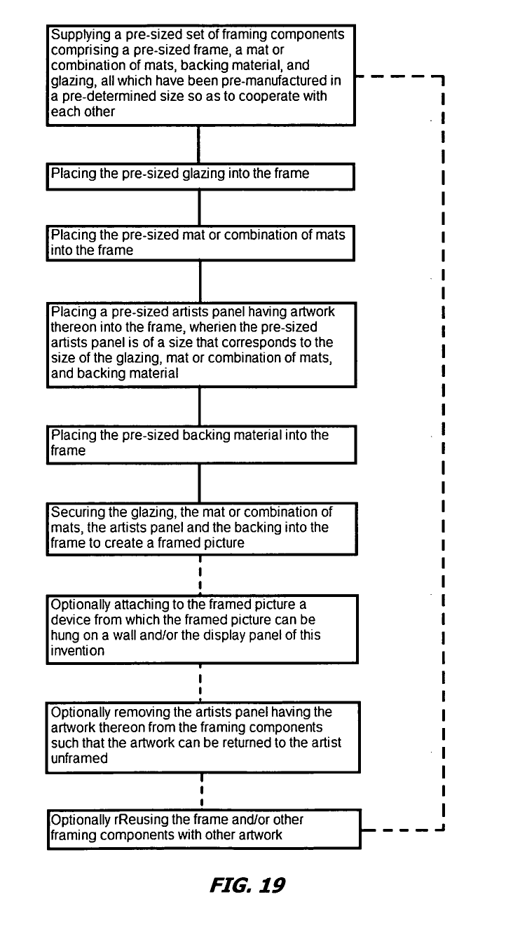

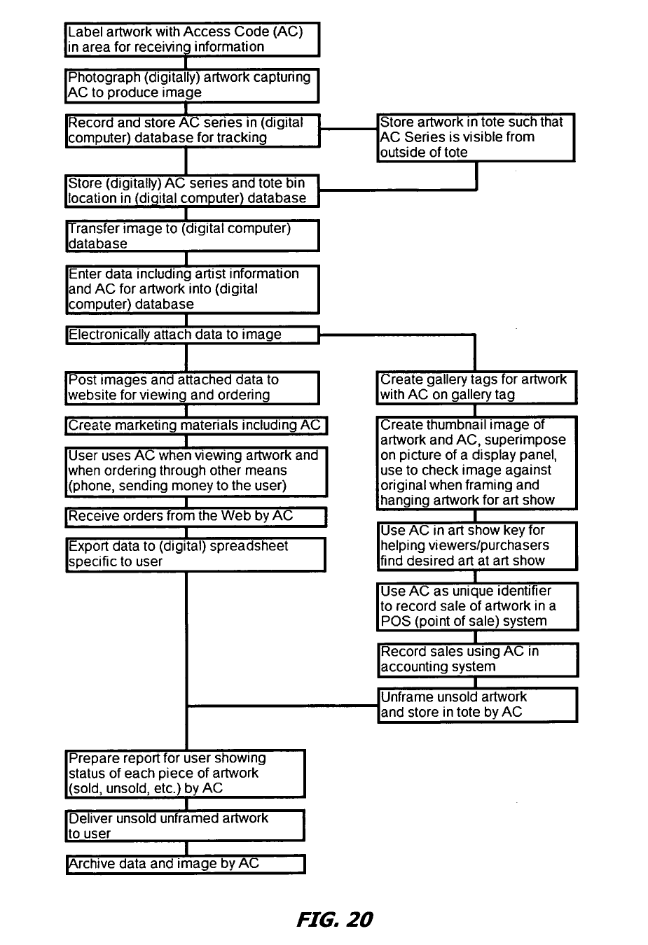

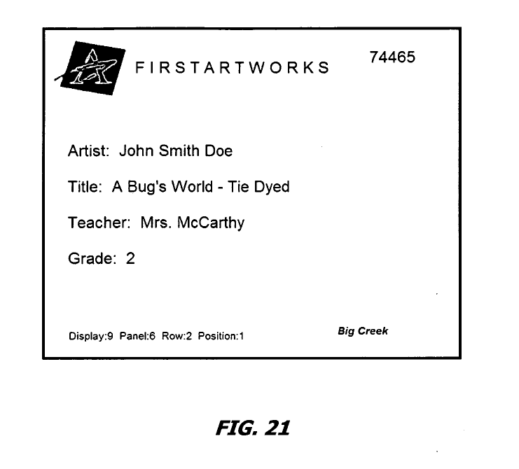

FIG. 18 is a generalized flow chart of a representative system for creating, framing, transporting, displaying and selling artwork of the present invention. FIG. 19 is a generalized flow chart of a representative method for framing artwork of the present invention. FIG. 20 is a flow chart of a representative method for tracking an exemplary access code used in the present invention. FIG. 21 is a mock-up of an exemplary gallery tag suitable for the present invention, showing information about the company providing the art creation services, the artist and the work, and the location of the artwork in the art show, including an access code.

1. Device for Displaying and Transporting Framed Artwork.

One aspect of the invention is a device for displaying and transporting artwork, generally referred to herein as framed artwork, framed pictures or framed media 1, preferred embodiments of which are shown in FIGS. 1-10. The framed media 1 may be or include, for example, photographs, drawings, posters, sketches, works of art such as watercolors or pastels, album covers, framed mementos and so forth, framed using the preferred framing method and comprising, as shown in FIG. 17, the artwork 6 on the artists panel 2, the backing 350, the mat or combination of mats 352, the glazing 354, and the frame 356. Thus, in a preferred embodiment, the present invention provides a device and a method for displaying multiple works of art, which in certain circumstances such as art shows and/or fund raising events may be desirable.

Referring to FIG. 1, in one embodiment the portable device 400 includes at least one panel 100, and preferably two panels 100 that are hingedly attached to each other. Panel 100 includes a framework 110 that is formed from at least two vertical members 20, 40 and at least two horizontal members 10, 30. More specifically, panel 100 is formed from a lower horizontal member 10 that is connected to a first vertical member 20 at a first end of the lower horizontal member 10 and a first end of the first vertical member 20. The other end of the first vertical member 20 is connected to one end of an upper horizontal member 30. The other end of the upper horizontal member 30 is connected to one end of a second vertical member 40. The other end of the second vertical member 40 is connected to the second end of the lower horizontal member 10 to form a framework. In the illustrated embodiment, the height H of the framework is defined by the length of the vertical members 20, 40 and the width W of the framework is defined by the length of the horizontal members 10, 30. The shape of the framework 110 can be square but more preferably is rectangular.

The horizontal and vertical members 10, 20, 30, 40 can be formed from many rigid materials, preferably materials that are light in weight but that are rigid enough and strong enough to support the weight of the framed media 1 that the device 400 is intended to transport and display. In suggested embodiments, the framework 110 is formed from horizontal and vertical members 10, 20, 30, 40 of square aluminum tubing that are welded, bolted or otherwise joined to one another to form the framework 110. A suggested size for square aluminum tubing that could be used to form the framework 110 of a panel 100 is about one and a half inches square, but the dimensions can range from a fraction of an inch to several inches depending on the strength of the material used and the desired aesthetic thickness of the members 10, 20, 30, 40. Also, other shapes, such as circular and other polygonal tubes, as well as angled members, and other dimensions as well as other tubing materials such as carbon, glass and ceramic composites; fiber composites; steel, titanium and other metals; and other known and future developed materials may be used.

In certain desirable embodiments, panel 100 further includes one or more intermediate horizontal members, which can be or can double as mounting strips 50. The mounting strips 50 can be formed from the same materials or similar materials as the horizontal members 10, 30 and vertical members 20, 40 used to form the framework 110 or from materials that differ in size, shape or composition than the horizontal members 10, 30 or vertical members 20, 40. In a preferred embodiment, mounting strips 50 include means for hanging 45 or otherwise attaching framed pictures, such as framed media 1, to the mounting strip 50. Such means for hanging 45 the framed media 1 include, but are not limited to, channels, clips, cables, hooks, strips, slots, holes, wires, and so forth, and preferably an S-shaped hook 45A discussed in more detail in connection with FIG. 12 below, that are capable of receiving framed media 1, such as framed pictures 90. The framed pictures 90 may include wires and eyelets, hooks or other hanging devices, such as the sawtooth hangers 47 shown in FIG. 17, on the backs or the tops of the frames 356 so as to cooperate with means for hanging 45 allowing the framed media 1 to be mounted on the panels 100 for transport and display. Preferably, the frame 356 comprises a sawtooth hanger 47 centered on the upper horizontal frame element.

In certain embodiments, strips, wires or the like, such as mounting strips 50, are extended between vertical members 20, 40 at appropriate heights for hanging the framed media 1 such that the framed media 1 hangs on the panels 100. The framed media 1 then can be hung directly on the mounting strips 50, wires or the like. In other embodiments, the horizontal members 10, 30 themselves can include hooks or nails or other means for hanging 45 that are adapted to receive hooks, wires or sawtooth hangers 47 that are or can be provided on the backs of the picture frames 356. Alternatively, slots or holes 65 can be provided in the horizontal members 10 or mounting strips 50 of the panel 100 so that one end of a hook or other means for hanging 45 can be inserted in the holes or slots 65 and the other end used to suspend the framed media 1 from a sawtooth or other hanger 47 that can be provided on the back of the framed media 1.

In the preferred embodiment, 1 inch strips of aluminum or other relatively rigid material extending horizontally across the panels 100 at selected heights to form mounting strips 50. In the illustrative embodiment of the invention disclosed herein, the top of the first or uppermost mounting strip 50 is located approximately 1-¾ inches from the bottom (the inner side) of the uppermost member 30. In other words, the top of the first or uppermost mounting strip 50 measures approximately 1-¾ inches from the inner facing side of the uppermost horizontal member 30 of the panel 100. The top edge of a second mounting strip 50, counting from the top of the panel 100, is located approximately 15-¾ from the bottom edge of the uppermost or top mounting strip 50. The top edge of a third mounting strip 50, counting from the top of the panel 100, is located approximately 15-¾ from the bottom edge of the second mounting strip 50. Similarly, the top edge of a fourth mounting strip 50, counting from the top of the panel 100, is located approximately 15-¾ from the bottom edge of the third mounting strip 50. The top edge of the fourth mounting strip 50 is located approximately 18 inches from the top (the inner side) of the lowermost horizontal member 10.

The framed artwork 90 is hung on the mounting strips 50 using broadened S-shaped hooks 45A, as shown in FIG. 12. More specifically, a hook 45A having an S-shaped cross-section and being approximately as wide as the sawtooth hanger 47 attached to the frame 356 is used to hang the framed media 1 on the mounting strip 50, and thus mount the framed media 1 on the panel 100. The S-hook 45A may itself hang from the mounting strip 50, but preferably is securely attached to the mounting strip using pop rivets 49 or the like to reduce the chance the S-hook 45A will rock relative to, or fall off of, the mounting strip 50. It has been found that the use of this specialized S-hook 45A to mount the framed media 1 on mounting strips 50 that are approximately 1 inch tall by ¼ inch thick provides a more secure mounting system, and helps prevent the framed media 1 from rocking back and forth during transport. Merely hanging the framed media 1 using wires and conventional hooks, nails and sawtooth hangers, or other single pivot mechanisms, could allow the framed media 50 to rock during transport, which could be detrimental to the framed media 1.

Referring to FIG. 2, the panels 100 may further include additional, optional intermediate vertical members 70 to add strength and/or rigidity to the panel 110 and to provide divided areas 80 to indicate where the framed pictures 90 should hang on a panel 100. Such a panel 100 would have multiple openings 80 in a gridwork pattern to provide a panel 100 with a number of display openings 80. Preferably, each display opening 80 includes one means for hanging 45 a framed media 1 so that one framed media 1 can be mounted and displayed in each opening 80. Thus, for example, a collection of framed media 1, such as framed pictures 90, may be mounted and displayed on panel 100, as best illustrated in FIG. 8. The size of each opening 80 can be varied depending on the chosen size of the framed media 1.

The size of each panel 100 and opening 80 can be varied, specifically the vertical distance between mounting strips 50 to accommodate various framed media 1 heights and optionally the distance between vertical members 20, 40 to accommodate various numbers of framed media 1. In a preferred embodiment, the panels 100 are of a size that can be rolled through a typical door opening of approximately 6 feet 8 inches high (80 inches) and can carry twelve pieces of framed media 1 in a three across (row) by four high (column) array. One suggested size for a row (that is, the vertical distance between neighboring mounting strips 50 or between the lowermost mounting strip 50 and the lowermost horizontal member 10) is approximately 16 inches high, and preferably approximately 15-¾ inches high, so that four rows can be provided vertically in a panel 100 and the panel 100 still would fit through a typical door opening. Thus, including the additional height of the horizontal members 10, 30 and any feet or casters 130, 230 attached to the bottom of the panels 100, the preferred panels 100 are approximately 72 inches high and approximately 64 inches wide.

Although it is preferred to maintain the panel 100 height H plus the height of any feet or casters 130, 230 at less than 80 inches so that the panel structures can fit through the vast majority of door frames, the width of the panels 100 can be varied depending on the selected array of framed media 1 to be mounted. For example, a single-column panel 100 could be on the order of approximately 18 inches wide, while a five-column panel 100 would be closer to approximately 90 inches wide. As the panels 100 themselves are on the order of 1-½ inches thick, and the framed media 1 mounted on the panels 100 fits within the footprint of the panels and does not add anything to the thickness, a pair of panels 400 would be approximately 3 to 4 inches thick, and a set of 8 pairs of panels 400 preferably would be no more than approximately 24 to 32 inches thick, approximately 72 inches tall, and approximately 5 to 5-½ feet wide (long), which can be rolled, moved and maneuvered into and out of a truck, through typical doors, and along typical hallways by two typical people.

In certain preferred embodiments, panel 100 also includes support structures such as feet, sleds, rollers, caster, or the like, generally designated by the reference numerals 130 and 230 and referred to herein using the term feet. The feet 130, 230 can be welded, bolted, inserted into holes or slots or otherwise connected directly to lower horizontal member 10 as illustrated in FIGS. 1 and 2. Alternatively, the feet 130, 230 can be connected to a leg or other extension (not shown) that is connected to a panel 100. Other suggested feet include other known means for rolling, sliding or otherwise moving furniture or other objects across a floor or other hard surface and include, but are not limited to, devices such as wheels, rollers, skids, sleds, low-friction strips, and the like. It is suggested that the feet 130, 230 are sized and/or positioned so that feet 130, 230 on adjacent panels 100, 200 do not interfere with each other when the two panels 100, 200 are folded or otherwise nested together to form the pair of panels 400 in the collapsed position, as shown in FIG. 5. It is also suggested that at least one of the feet 130, 230 per pair of panels 400 include some type of means for locking (not shown) to prevent the pair of panels 400 from inadvertently moving or rolling when the pair of panels 400 has been placed in a desired location. The feet 130 preferably are wider that the width of the lowermost horizontal member 10 and as a result are offset from one panel 100 to the next panel 200 to allow for the pair of panels 400 to fully close. The distances between the mounting strips can be adjusted based on the size of the frame 356 used.

The preferred shape of the framework for the panels 100 is rectangular, based on the preferred shape of the frames 356. The primary horizontal and vertical members 10, 20, 30, 40, that is the lowermost and uppermost horizontal members 10, 30 and the outermost vertical members 20, 40, can be formed from many rigid materials, preferably materials that are light in weight but that are rigid enough and strong enough to support the weight of the framed media 1 that the device is intended to transport and display.

Referring generally to FIGS. 3 through 5, in one preferred embodiment, two similar panels 100, 200 are attached to each other at one vertical end of each of the panels 100, 200 with a hinge 120 so that the two panels 100, 200 can be folded together for storage and transportation to another location. At a location, the pair of panels 400 can be unfolded into an angular configuration for display purposes, with the angle between the panels 100, 200 allowing the pair of panels 400 to be free-standing. Additionally, if the panels 100 have framed media 1 hanging from the panels 100, a pad material 84 or other protective material can be inserted between folded panels 100, 200 to protect the framed media 1. In such a situation, it can be preferable for the framed media 1 on each panel 100, 200 to face inwards relative to the folded pair of panels 400, such that the pad material 84 protects the fronts of the framed media 1. The hinges 120 on the pair of panels 400 preferably are offset to allow for the pair of panels 400 to close with the pad material 84 (disclosed in connection with FIG. 15 below) inside. For example, offsetting the hinges 120 about ¼ inch generally is sufficient.

As can be seen in FIG. 3, an unfolded pair of panels 400 preferably is free standing. Opening the panels 100, 200 to a 90° angle provides a relatively stable configuration allowing the panels 100, 200 to remain upright in the open position. Of course, the pair of panels 400 can be more or less than 90° relative to each other and still remain upright, with between 45° and 135° being preferred, and between 60° and 120° being more preferred. As can be seen in FIG. 4, a partially unfolded pair of panels 400 is shown illustrating the manner in which the pair of panels 400 can be folded for storage, transport, or just to save floor space. A partially folded pair of panels 400 as illustrated in FIG. 4 can more easily (stably) be rolled to another location for display or storage than a fully folded pair of panels 400, especially if rollers or casters are used as the feet 130. In a preferred embodiment, when a pair of panels 400 is folded together, the display surfaces 102, 202, which are the surfaces on which the framed media are mounted, face inwardly so as to protect any framed pictures hanging from the display surfaces 102 and 202. It is between the display surfaces 102, 202 that pad material 84 is placed to further protect the framed media 1. As can be seen in FIG. 5, a pair of panels 400 may be folded together completely so that the pair of panels 400 occupies less floor space, and is ready for storage or transport.

Referring to FIG. 6, a plurality of attached pairs of panels 400, for example four pairs of panels 400, may be arranged and stacked vertically (or horizontally if the pairs of panels are placed lying down) as a brick so that the panels 100 take up less space and can be moved as a single unit. Such a brick of panels 100 can moved as a single unit and desirably should fit through a typical door opening.

As disclosed above, two panels 100, 200 preferably are hingedly attached or at least pivotally attached to each other to form a pair of panels 400. The panels 100, 200 can be hingedly attached using a means for hingedly attaching one item to another item such as a door hinge or piano hinge. It is also possible to use a double hinge to allow three or more panels 100 to be linked and alternately folded against each other. Such double-hinged panels could be closed and opened into a zigzag standing position. An example of a double hinge is illustrated and described in U.S. Pat. No. 6,112,445. An example of one type of very simple, pivoting type hinge is illustrated in U.S. Pat. No. 6,095,226. Either of these types of hinges may be suitable for the present invention as well as conventional hinges such as those used on doors and cabinetry.

Referring to FIGS. 7 through 9, a plurality of pairs of panels 400 can be arranged together to form stand alone displays. As can be seen in FIG. 7, four such pairs of panels 400 may each be unfolded at 90° angle and then arranged in a back-to-back orientation to provide a cross- or X-shaped display of multiple panels 100 that allow the display multiple pieces of framed media 1 in a limited amount of space. As can be seen in FIG. 8, such a cross- or X-shaped display provides an excellent vehicle for displaying framed media 1. As can be seen in FIG. 9, multiple panels 100, 200, 600, 700 alternatively can be arranged in a zigzag pattern to provide a display suited for a longer area such as a hallway.

Referring to FIG. 9, an exemplary zigzag display of panels can be formed with three or more pairs of panels 100, 200; 600; 700; 800, 900 and two individual panels 300 and 500. The first pair of panels 100, 200 are joined at hinge 120, the second pair of panels 600, 700 are joined at hinge 620, and the third pair of panels 800, 900 are joined at hinge 820. Single panel 500 is placed back-to-back with panel 100 and single panel 300 is placed back-to-back with panel 700 to make a two-sided zigzag display. A crossbar 95 also may be provided across and attached to the tops of the panels 100, 200, 300, 500, 600, 700, 800, 900 to stabilize a display. It should be noted that the panels 100 are portable and can be arranged in a wide variety of other patterns and various sizes of displays, and is not limited to cross- or X-shapes or zigzags.

Referring to FIG. 12, a preferred embodiment of S-hook 45A is shown. Generally, S-hook 45A is a bent piece of material with a top hook 52 that fits over mounting strip 50 and a bottom hook 54 that fits within sawtooth hanger 47. In one preferred embodiment, top hook 52 fits over mounting strip 50 and S-hook 45A is riveted 49 to mounting strip 50. Sawtooth hanger 47 on framed media 1 then can be hung over bottom hook 54. The width of S-hook 45A preferably is as close as possible to the interior dimension of sawtooth hanger 47 to reduce or prevent any rocking and side to side movement of framed media 1 when hung on S-hook 45A. Although the rivet 49 is optional, it helps prevent S-hook 45A from rocking on or falling off of mounting strip 50, especially during transport. Further, any known or future developed method or means for attaching S-hook 45A to mounting strip 50 is suitable, as well as eliminating top hook 52 such that S-hook 45A is J-shaped.

Referring to FIG. 13, a backing material 82 preferably is attached to the panel 100 on the panel side opposite where the framed media 1 is mounted, namely on the side of the panel 100 opposite the display face 102. The backing material 82 has approximately the same outer dimensions as the panels 100 such that when attached to the panels 100, the backing material 82 completely or substantially completely fills the opening between the uppermost member 30 and the lowermost member 10 and the outer vertical members 20, 40. The backing material 82 provides a backdrop for the framed media 1 such that a viewer cannot see between neighboring pieces of framed media 1 when mounted on the panels 100, and therefore cannot see through the panels 100. The preferred backing material 82 has a photo gray color as it has been found that such a color is the best way to show framing that contains only black (the preferred color of the frame 356) and white (the preferred color of the mat 352), as gray is a blend between the two neutral colors of black and white. The backing material 82 can be attached to the panels 100 by any known and future developed means, such as VELCRO® hook and loop material, clips, rivets, adhesives, and the like. It is preferred that the backing material 82 be removably mounted for cleaning and replacing with a different color material, if desired.

Referring to FIG. 16, a brick of panels 100 can be covered with an envelope of material, preferably a flexible yet strong material, to protect the panels 100 and any wall or door frame that the panels 100 may come into contact with while moving the panels 100, and to help to keep the pairs of panels 400 together as the brick. A brick of panels 100 also can be bound together for storage and transportation with a strap 124 or other means of securing the panels 100 together. As such, an exhibit of greater than 1000 pieces of framed media 1 can be provided with six bricks of panels, with each brick made up of eight pairs of panels 400 and each panel 100 including twelve framed media 1 such as framed pictures 90, yet the entire collection would take up a volume of only about 6 feet by 7 feet by 12 feet. It is envisioned that two people would be able to unload and set up such a 1000+ piece art exhibit in a short amount of time, preferably under an hour. Exhibits of greater size, for example 2000 or more framed media 1 may be possible. It is suggested that the folded pairs of panels 400 further include some form of protection such as the pad material 84 mentioned above, or a sheet of egg shell foam between the display faces 102 and 202 of the panels 100 and 200 to protect the framed media 1 that have been hung on the panels 100 and/or to limit frame 356 movement during transportation. A pair of panels 400 also can include a means for keeping a pair of panels 400 in the folded closed position show in FIG. 5 such as a hook 140 (shown in FIG. 4) or other type of locking mechanism located at the vertical edge of one of the pair of panels 400 opposite the vertical edge having the hinge 120.

2. Device, Method and System for Creating, Framing, Transporting, Displaying and Selling Artwork.

Referring to FIG. 18, the present invention is a device, method and system for creating, framing, transporting, displaying, and selling framed artwork, such as framed media 1. The preferred embodiments of the device are as disclosed above. The system is the use of the device in conjunction with the method disclosed immediately below and/or in conjunction with the framing method disclosed in the next section below.

In one embodiment, the method generally includes the steps of: (1) supplying a specialized sheet of paper, herein generally referred to as the artists panel 2, to an individual or a group of individuals wherein the artists panel 2 includes an identified area for receiving artwork 6 produced by an individual or a group; (2) having the individual or group of individuals produce artwork in the identified area for receiving artwork 6 provided on the artists panel 2; (3) marking the artists panel with information related to the identification of the individual or group of individuals in an area for receiving information 8 generally at the margin of the artists panel 2; (4) framing the artists panel 2 in a frame using framing components, comprising one or more of a backing sheet 350, a mat or combination of mats 352, glazing 354, a frame 356, and a hanging means 47; (5) hanging the framed artists panel 2, namely framed media 1, on a portable device, namely one or more panels 100, for displaying and transporting a plurality of framed media 1; (6) transporting the plurality of panels 100 to a display location; and (7) displaying a plurality of framed media 1 on one or more panels 100, preferably a plurality of panels 100 holding twelve or more pieces of framed media 1, to a viewer or a group of viewers at an art show, for example.

The number and order of these steps can vary, and there can be additional steps as well. For example, the framed media 1 can be marked with an individual's identification information before or after the individual produces artwork. Additionally, the artwork can be offered for sale and any unsold artwork unframed and returned to the artist. Further, the artwork can be digitally photographed for electronically viewing and reproducing. Also, the method of transporting the plurality of panels 100 is unique in that the panels 100 preferably are utilized in hinged pairs 400 that are folded face-to-face and bundled together with other hinged pairs 400 of panels 100 to form a convenient and more easily transportable brick of panels 100.

For example, referring back to FIGS. 3 through 6, the method step of folding a hinged pair 400 of panels 100 is shown from open (FIG. 3), being closed (FIG. 4), closed (FIG. 5), to being bundled together with other hinged pairs 400 of panels 100 (FIG. 6). As mentioned above, a pad 84 preferably is inserted between panels 100 as the panels 100 are being closed to protect the framed media 1. Referring back to FIGS. 7 through 9, illustrations of the display steps of the system and method are shown. These figures give some exemplary illustrations of how the framed media 1 can be displayed using the panels 100 of the invention.

Referring to FIGS. 10 and 1 1, an exemplary artists panel 2 is shown. As used herein and as mentioned above, the term artists panels includes, but is not limited to, any surface upon which artwork can be produced such as paper, canvas, fabric, linen, cardboard, synthetic surfaces and so forth. The preferred frame 356 has a size (outer dimensions) of approximately 18 inches by approximately 15 inches. Such frame 356 dimensions result in inside dimensions (that is, the dimensions inside the frame 356 available for receiving and containing the framing components) of approximately 16 inches by approximately 13-⅛ inches for receiving the framing components, namely, the backing 350, the artwork 6, the mat or combinations of mats 352, and the glazing 354.

Preferably, the artists panel 2 has dimensions of approximately 15-⅞ inches by approximately 13 inches, and an interior area that is includes an identified area for receiving artwork 6 that is approximately 10-⅞ inches wide by approximately 8 inches high, leaving about 2 inches or so of border around each edge that can be covered by the mat or combination of mats 352 during framing. The backing 350, the mat or combination of mats 352, and the glazing 354 preferably have the same outside dimensions as the artists panel 2, which in the preferred embodiment are approximately 15-⅞ inches by approximately 13 inches. Of course, the size of the artists panel 2, the artwork area 6 size and the frame 356 and framing components size can be varied as desired. The interior area identified for receiving artwork 6 provides a template for the artist to create art. The area identified for receiving artwork 6 may be designated or set off by lines, shading or other markings 4.

In particularly preferred embodiments, the artists panels 2 are supplied to groups of artists or aspiring artists (and indeed, any group at all), such as, for example, kindergarten, elementary, middle or even high school students so that the students can produce artwork by drawing, coloring, painting, pasting objects and so forth on the artists panels 2. As used herein, the term artist is defined broadly and includes any individual or group of individuals who produce art and particularly includes children with no formal training in the arts. Similarly, as used herein, art and artwork are defined broadly and include, but are not limited to, any expression by drawing, coloring, painting and so forth and includes collages and other multimedia expressions.

The artists panel 2 also preferably includes one or more areas for receiving information 8 related to identification of the individual producing the artwork and where the individual is located, so that the artwork can be associated with the artist, location, teacher, class or school, for example. The area for receiving information 8 related to identification can be on the front or back surface of the artists panel 2, but preferably is on the front surface and not within the area for receiving artwork 6. In certain embodiments, the identified area for receiving artwork 6 and the specific area for receiving information 8 related to identification is on the back surface of the artists panel 2. In other embodiments, the specific area for receiving information 8 related to identification is on the front surface of the artists panel 2 and is not within the area for receiving artwork 6. The artists panel 2 may include a bar code 22 or radio frequency identification (RFID) 24 to provide for tracking. Preferably, the bar code 22 or RFID 24 is located on the front side of the artists panel 2 or near the border of the front side outside of the area that is identified for receiving artwork 6. The bar code 22 or RFID 24 also can be located on the back of the artists panel 2. The area identified for receiving artwork 6 may be designated by lines 4, shading or other markings to provide a template that will guide the artist as to where to focus their artistic efforts.

In a preferred embodiment of the overall system, the artists panel 2 are supplied by a supplier to group of artists, such as, for example purposes but not limited to, a school class as part of a class project and/or fund-raising event. Other illustrative groups can include boy and girl scout troops, boys and girls clubs, team building seminar groups, after school classes such as religious schools and stay and play classes, and other schools and groups of people. Alternatively, the school or the students may supply their own artists panels 2. The artists panels 2 are distributed to the students so that the students can produce a work of art or glue their own art paper to the artists panel 2. The finished works of art then are returned to the supplier so that the supplier can frame the artwork 6 using the framing components 350, 352, 354, 356. Alternatively, the framing components 350, 352, 354, 356 can be supplied to the school (or whatever group or individual is creating the artwork) such that the artwork 6 may be framed by the artists themselves at the school with the framing materials supplied to them by the supplier, or by the school or other group utilizing the invention. The artwork 6 also can be digitally scanned or preferably photographed or photocopied, preferably digitally, so that an image of the artwork 6 can be viewed by the student, the student's parents and other individuals, and electronically reproduced.

In a preferred embodiment, the artwork 6 is digitally photographed to capture an image of the artwork 6 produced by the artist. The digitally photographed image then may be stored on a computer system, network, internet, CD-ROM and so forth so that individuals may retrieve and view the image. In particularly preferred embodiments, individuals can view the artwork 6 over the internet. In a preferred embodiment, an access code is assigned to a piece of artwork 6 so that an individual can identify and view the artwork 6 over the internet by using the access code. Written material, such as a pamphlet, with information about the website, services, prices for framing, copies and so forth may be provided to the student so that the students can take information home with them to their parents.

In addition, a unique anonymous or substantially anonymous identifier can be assigned to the student artist. The identifier can be the artist's first name, age, artwork title, keyword selected by the artist, grade, school, grade and/or teacher. Preferably, for privacy and safety, the student artist is not identified by last name. Individuals, for example, the student artist's parents, may purchase the framed original artwork, namely the framed media 1, from the supplier after an image of the original artwork 6 has been digitally photographed and stored in some electronically retrievable form. Copies of the original artwork 6 also may be purchased either framed or unframed. For example, parents of the student artist may view the framed, original artwork 6 at an exhibition held by the school and purchase the framed original artwork 6 at the exhibition. The parents may also order copies, framed or unframed at the exhibition or though a website provided by the supplier.

The identifier can be, or can be combined with, an access code. This access code can be used to track artwork 6 from creation through the framing process, art show and internet web sales, to unframing and return to the artist. Further, the access code can be used to locate the artwork 6 at an art show or on the internet and to order the artwork 6. Additionally, the access code can be used as a unique identifier for database storage, sales, billing, accounting and archiving artwork 6. It has been found that the use of such an access code or the equivalent can increase the efficiency and accuracy of the instant method and system.

The use of an access code starts when the artwork 6 is labeled. The label can be simply numeric or alpha numeric, can be a serial number bar code 22 (i.e. 000001, 000002, and etc.), or an RFID 24. The label can be a number on a sticker or it can be printed directly on the artists panel 2, preferably in the area for receiving information 8. As disclosed herein, the artwork 6 is photographed for storage, retrieval, and later reprinting. When the artwork 6 is photographed, the access code is digitally captured. After photographing the artwork 6 and the access code, the artwork 6 can be stored in tote or other container for protection. Preferably, the tote is transparent such that the access code can be viewed through the tote, or the access code is otherwise made visible.

The access code preferably is created in a series unique to a user. For example, a school having 1000 students may be assigned the access code series 23000000 through 23001000. This series is recorded and stored for internal tracking. The access code series is stored, along with the tote bin location, in a database, such as a digital computer database on a computer hard drive. After digitally photographing the artwork 6, the images are transferred to a database for data entry. The images database can be the same as or different from the access code database. During data entry, the artist information and the access code on each piece of artwork 6 is entered and stored and electronically attached to the image of the artwork 6. The images of the artwork 6 and the attached data (including the access code) then are sent to a website for viewing by browsers and purchasers and for allowing purchasers to order copies of the artwork 6.

If desired, marketing materials can be created for advertising the sale of the artwork 6. Preferably, the marketing materials, and specifically child specific marketing materials, include the access code for enhanced privacy. Browsers and purchasers, such as parents and others, use the access code when viewing the artist's framed artwork 6 and when ordering either the original or copies of the artwork 6 through other means, such as by telephone, sending money to the user (school). In a preferred embodiment, orders for artwork 6 received from the internet are made using the access code as the identifier. For reporting purposes, the data, preferably minimally comprising artist information and AC series, is exported to a spreadsheet and provided to the user.

As disclosed in more detail elsewhere herein, in a preferred embodiment, artist specific gallery tags are created for the sale of the artwork 6 in an art show. The access code preferably is placed on the gallery tag. Also, a thumbnail photographic image of the artwork 6 and the access code can be taken by, for example, a digital camera or a digital scanner, and the thumbnail image superimposed on a picture of a display panel 100. This can be used to check the artwork 6 and access code versus the original artwork 6 when framing and hanging the artwork 6 for the art show. More specifically, an electronic image of a display panel 100 can be created with a matrix of thumbnail images of artwork 6 superimposed thereon to provide an idea of how each display panel 100 actually will appear when in the art show. As such, the access code can be used in an art show key (program or booklet, for example) used to help viewers, attendees and purchasers find specific artwork 6 at the art show.

When the artwork 6 is purchased at the art show, the access code can be used as the unique identifier to record the sale in, for example, a point of sale system. Likewise, the access code can be used as the identifier in accounting programs and archiving programs and in data and imaging programs.

After an art show, the unsold original artwork 6 can be unframed and stored in the tote until returned them to the user or artist. The access code also can be used in this process as the identifier for locating the correct tote or the correct location for the stored artwork 6. Similarly, a report can be prepared for the user showing the status of each piece of artwork 6 (for example, sold, unsold, etc.) by access code. Typically lastly, unsold pieces of artwork 6 are returned to the user.

The above disclosed method steps for using an access code are for illustrative purposes and represent the best mode contemplated by the inventors. However, alternative methods for using an access code using more or fewer of the disclosed steps and in different orders, including carrying out some steps concurrently (parallel) to carrying out other steps is contemplated. For example, while the step of photographing the artwork 6 must be carried out prior to storing the photograph in a database, the steps relating to using the access code in an art show can be carried out prior, concurrently, or subsequent to the step relating to offering the artwork for sale on the internet. Thus, except where physically impractical, the various steps are presented in a certain order for ease of description, but the invention is not limited to the presented order. In particular, FIG. 20 illustrates one such parallel order.

Referring to FIG. 21, a mock-up of an exemplary gallery tag suitable for the present invention, showing information about the company providing the art creation services, the artist and the work, and the location of the artwork in the art show, including an access code, is shown. This gallery tag can be placed next to the framed artwork 90 when the framed artwork 90 is placed on the panels 100 for display at an art show. Information that can be placed on the gallery tag includes the providing company's logo, the providing company's name or trade name, and the access code, as shown on the top row of FIG. 21. Additional information can include information about the artist, the title of the work, and the teacher and grade of the artist, in school-related situations, as shown in the middle section of FIG. 21. Further information can include the location of the framed artwork 90 within a show, such as the display number (which, for example, can be a reference number or letter representing the art show location or a grouping of panels within an art show), the panel 100 number within the display, and the row and the position (column) of the framed artwork 90 on the panel 100, as shown on the bottom row of FIG. 21. The school or other user name also can be shown, as shown on the lower right corner of FIG. 21. More or less information can be included on the gallery tag as desired.

Typically, the artwork 6 is framed using the present invention's method for framing artwork in a specialized picture frame 356 using specialized framing components 350, 352, 354, 356 and a specialized framing process, disclosed below in the next section. For example, the framing process may include placing and arranging the preferred specialized artists panel 2 on a pre-sized backing material 350, then arranging and placing a pre-sized mat or combination of mats 352 over the artists panel 2. Preferably, the artists panel 2, the backing boards 350, and the mats 354 are similarly sized (all having the same outer dimensions of approximately 15-⅞ inches by approximately 13 inches in the preferred embodiment, and all having the same outer dimensions as each other for embodiments of different sized artwork) to simplify framing. The mat 352 preferably has an opening that is sized and shaped to correspond to the identified area for receiving artwork 6 (approximately 10-⅞ inches by approximately 8 inches for the preferred embodiment, and other sizes for other embodiments) and covers any marks outside of the identified area for receiving artwork 6 that identify this area and the area for receiving information 8. The matted artists panel 2 also is preferably covered by a glazing 354, such as a sheet of glass, clear plastic such as acrylic or PLEXIGLAS® polymer, LEXAN® polycarbonate resin, and other clear materials suitable for use in framing, and then framed in an appropriately pre-sized and shaped frame 356. The frame 356 also preferably includes a device from which the framed picture can be hung on a wall and/or the display panel of this invention, such as a hanger 47.

The framed media 1, such as framed artwork 90, then is hung on the present invention's device for displaying and transporting artwork, as disclosed in more detail above, transported to a desired location, and displayed for viewing and for sale. A specialized gallery tag can be created and associated with the framed media 1. The gallery tag preferably comprises information about the artist gleaned from the information supplied by the artist and the school, generally as written onto the area for receiving information on the art template, is printed on cardstock, and is associated with the respective piece of framed media 1 to help in making a more complete and professional presentation of the framed media 1, imitating an art gallery in which information about the artwork and the artists is contained on a plaque mounted on the wall next to the artwork. Of the many contemplated variations, one is that the artwork 6 need not be framed and as such can be mounted directly on the panels 100.

Framed media 1 that is sold can be taken by the purchaser. Individuals, for example the student artist's parents, may purchase the framed media 1 from the supplier, preferably after an image of the original artwork 6 has been digitally photographed and stored in some electronically retrievable form. Copies of the original artwork 6 also may be purchased either framed or unframed. Framed media 1 that needs to be shipped to the purchaser is placed in a specialized shipping box created for the invention, which is of a size and configuration to contain and protect the framed media 1 during shipping. Unsold framed media 1 is transported back to a disassembling location, at which the artwork 6 is removed from the framing components 350, 352, 354, 356, the artwork 6 is returned to the artist, and the frame 356 and some or all of the other framing components 350, 352, 354 are reused. The fee charged for the framed media 1 can be retained by the supplier, retained by the school or other institution, or split among various parties including a school or other institution and the supplier.

Referring to FIGS. 14 through 16, illustrations of the panels 100 being prepared for and ready for transportation are shown. As can be seen in FIG. 14, three pairs of panels 400 having backing panels 82 and panel pad material 84 covers are shown. Backing panels 82 not only provide for an aesthetic backdrop to the display of the framed media 1, but also protect the backs of the framed media 1. The combination of backing panels 82 and pad material 84 cooperate to protect the framed media 1 during transportation and storage. As can be seen in FIG. 15, only one pad material 84 is needed per pair of panels 400, as when the pair of panels 400 is folded together, the pad material 84 is sandwiched between the panels 100, 200.

Referring to FIG. 16, a front view of a brick of panels covered by a protective envelope 92 is shown. A brick of panels can be covered with this envelope of material 92, which preferably is a flexible yet strong material, to protect the panels 100 and any wall or door frame that the panels 100 may come into contact with while moving the panels 100, and to help to keep the pairs of panels 400 together as the brick. The envelope of material 92 can be provided in different sizes, such as for a single pair of panels 400, for two pairs of panels 400, and for four pairs of panels 400. Any size can be made. The envelope of material 92 also provides for improved aesthetics during transport and storage.

Dollies can be used to transport a brick of panels. Dollies can be placed on either end of the brick so as to provide a set of wheels (assuming the panels 100 do not have their own rollers or casters as the feet 130) to move the brick. A strap 124 holds the brick 126 together, and can wrap around or be attached to the dollies to keep the brick 126 and the dollies together.

The above disclosed method steps for creating, framing, transporting, displaying and selling artwork are for illustrative purposes and represent the best mode contemplated by the inventors. However, alternative methods for creating, framing, transporting, displaying and selling artwork using more or fewer of the disclosed steps and in different orders, including carrying out some steps concurrently (parallel) to carrying out other steps is contemplated. Thus, except where physically impractical, the various steps are presented in a certain order for ease of description, but the invention is not limited to the presented order.

3. Method for Framing Artwork.

Referring to FIGS. 17 and 19, the present invention further provides a method for framing artwork comprising the steps of (a) providing a pre-sized artists panel 2 having artwork 6 on an artwork area 6 and identifying information about the artist on an information area 8 separate from the artwork area 6; (b) providing a pre-sized combination of framing elements including a frame 356, a transparent glazing 354, a mat or combination of mats 352, a backing board 350, and a hanger 47; and (c) mounting the artwork 6 and framing components 300, 352, 354 within the frame 356. The pre-sized artists panels 2 are sized to cooperate with the framing components 350, 352, 354, 365 so as to allow the efficient and economical framing of artwork 6.

For example, the method for framing artwork may include, after the artwork 6 has been created on the preferred specialized artists panel 2 (this term will continue to be used herein as a general term for any paper, sheet, canvas, board, etcetera, that can be used as the substrate for the artwork), placing and arranging the artists panel 2 on a pre-sized backing material 350, then arranging and placing a pre-sized mat or combination of mats 352 over the artists panel 2. Preferably, the artists panels 2, the backing boards 350, and the mats 352 are similarly sized (all having the same outer dimensions of approximately 15-⅞ inches by approximately 13 inches in the preferred embodiment, and all having the same outer dimensions as each other for embodiments of different sized artwork) to simplify framing. The mats 352 preferably have an opening that is sized and shaped to correspond to the identified area for receiving artwork 6 (approximately 10-⅞ inches by approximately 8 inches for the preferred embodiment, and other sizes for other embodiments) and covers any marks outside of the identified area for receiving artwork 6 that identify this area and the area for receiving information 8. The matted artists panel 2 also is preferably covered by a glazing 354, such as a sheet of glass, clear plastic such as acrylic or PLEXIGLAS® polymer, LEXAN® polycarbonate resin, and other clear materials suitable for use in framing, and then framed in an appropriately pre-sized and shaped frame 356.

Alternatively, the method steps can be re-ordered to placing the glazing 354 into the frame 356, placing the mat or combination of mats 352 into the frame 356 behind the glazing 354, placing the artists panel 2 into the frame behind the mat or combination of mats 352 such that the artwork 6 faces the glazing 354 and can be seen by a viewer, placing the backing board 350 into the frame behind the artists panel 2, and securing the glazing 354, mat or combination of mats 352, the artists panel 2, and the backing board 350 into the frame 356.

The frame 356 also preferably includes a device from which the framed picture can be hung on a wall and/or the display panel of this invention, such as hanger 47. The method also can include an optional step of removing the artwork 6 from the framing components 350, 352, 354, 365 such that the artwork 6 can be returned to the artist unframed and/or the frame 356 and/or other framing components 350, 352, 354 can be reused with other artwork 6.

By having a set of pre-sized framing components 350, 352, 354, 356 for use in connection with a pre-sized artists panel 2, the framing process is made more convenient, more economical, and can result in a more consistent framed product. Additionally, as the framing components 350, 352, 354, 356 are of a standard size, each framing component 350, 352, 354, 356 can be used in combination with the other components without having to search for a proper sized component. Further, each of the framing components 350, 352, 354, 356 can be reused for future framing without having to resize the specific framing component 350, 352, 354, 356.

The above disclosed method steps for framing artwork are for illustrative purposes and represent the best mode contemplated by the inventors. However, alternative methods for framing artwork using more or fewer of the disclosed steps and in different orders, including carrying out some steps concurrently (parallel) to carrying out other steps is contemplated. Thus, except where physically impractical, the various steps are presented in a certain order for ease of description, but the invention is not limited to the presented order.

### EXAMPLE

The following example of the system and method of the present invention provides an example of how a person, such as a group administrator such as a teacher would initiate use of the present system, method and devices. This example is meant to be illustrative of the systems and methods disclosed herein and also of a business method for providing art show and framed art sales services for charity, fundraising and for profit. This example is illustrative only and is not meant to be limiting to any of the systems and methods of the present invention or their equivalents.

A company can be established to provide the various materials, services, devices and methods (referred to generally herein as the invention) to users (users are the schools, organizations, etcetera to which the present invention is directed). Such a company can be dedicated to growing the arts by encouraging children, young adults and others to explore their creativity. If desired, the company can give back a certain percentage of its revenue from providing the invention directly to the user, thus providing a fund raising opportunity for the user. As custom framing can be cost prohibitive for many people and organizations, the invention helps to ensure affordable prices for the framed art by utilizing a custom method for framing the artwork.

The company can provide the art templates, namely the artists panels, pick up and frame every piece of artwork, and host the art exhibitions. This allows the user to spend more time doing other activities. Each piece of artwork is professionally framed using the framing components and the framing method. For example, the framing components can comprise black picture frame molding, acid free or acid free buffered mat boards and backing boards, and acrylic glazing.

The company can work with the user and the artists to host an art exhibition. After every artist has created their masterpiece, the company frames the artwork using the framing method of the present invention and showcases the artwork, gallery style, at the art exhibition. Prior to the art exhibition, the company can post every artist's artwork online over a computer network, such as the internet. Each piece of artwork is given an access code to view the artwork.

The artists panels can be purchased or supplied pre numbered, with or without bar code identifiers, and with or without RFID. For example, the company can manually apply, or not, the bar code labels then distribute the artists panels to the school. Sometimes, the company can apply the bar code and/or access code labels after the artwork comes back from the school. The company also can place the RFID labels to the artists panels either manually or by machine.

After the artwork has been created, the company then can photograph the artwork to create the digital images of the artwork. In photographing the artwork the company preferably captures the entire piece of artists panel. The company then can transfer the photographic images of the artwork either manually or through automatic systems to a database consisting of photographic images. This can be done in many conventional manners, such as flash memory cards or direct download. Preferably, the images for one user are downloaded to a file on a computer server specifically set up for the user.

Once this download transfer of the artists panels has been made, the artist's information from the area for receiving information can be pulled into a data entry screen. From this screen, the artist's information can be inputted into a database and also permanently attached to the image. In other words, the unique art access code for each piece of artwork is electronically applied or attached to the data record. For example, the image file can be stored in the data file or the data file can be stored in the image file, as long as the two can be linked. Once this conversion has been made, the images can be sent to the corresponding user file on the server for additional data entry, if necessary or desired. Once data entry has been made, the image can be attached to the data record and the two preferably are permanently linked. The information then can be pushed or published on a website and parents, family members, artists, and others can view the framed art by entering their access codes.

The database also can be used to export the data into user specific marketing materials (fliers, invitations, etcetera) and the data is exported to gallery tags. Each piece of marketing material preferably contains the access codes, which can be used as the main identifier for all purchases. For example, the access codes on the gallery tags can be used and recorded on all sales at the art shows. Likewise, the access number can be used for internet website orders. Once an art show is complete (both the on-line art show and the on-site art show) all purchases can be categorized by access code and the data can be analyzed and shared with the user. The user can be shown participation by student, participation by teacher, or participation by grade, for example. Further, the portion of the sales proceeds due to the user as a result of the art show can be calculated and provided to the user.

The access codes also can be used to track the artwork through an inventory system. A status code also can be assigned to all artwork to show electronically where the artwork is in the system. For example, a status code of A1 can mean the artwork has been received but not photographed, a status code of A2 can mean the artwork has been photographed but no data has been attached, etcetera. Additionally, when parents or other purchasers of the artwork ask the company to ship an order (originals or reproductions), the purchaser can be instructed to give the company an address for shipping. This address can be attached to the access code. Further, a key can be printed to help purchasers to find their desired artwork at the art shows and on the internet web site. This also can use the access code.

If an individual desires to purchase the artwork, the individual can come to the art show event and purchase the framed artwork. The framed artwork can be purchased by typical methods, such as by sending a check to the company or directly to the user. Alternatively, the framed artwork can be purchased online through a secure website by entering the access code. The night of the exhibition can be great fun. The company arrives before the art exhibition and prepares the art exhibition for viewing. The artwork is hung on the panels, pairs of panels are folded together and transported to the art exhibition, and set up for display. The custom brick envelopes, backing materials and pad materials help protect the artwork during transportation and provide enhanced aesthetics during the exhibition. The custom dollies and trucks make setting up and cleaning up simple and fast.

When an art show is finished, both on-line and on-site, the final step is to reconcile the art show. More specifically, all orders for artwork can be recorded (sold artwork), all artwork that was returned to the user can be recorded (unsold artwork), and each access code on the artwork can be checked against the orders recorded. The artwork returned to the used can include a report showing what has been returned (unsold artwork) and what has not (sold artwork).

The foregoing detailed description of the preferred embodiments and the appended figures have been presented only for illustrative and descriptive purposes and are not intended to be exhaustive or to limit the scope and spirit of the invention. The embodiments were selected and described to best explain the principles of the invention and its practical applications. One skilled in the art will recognize that many variations can be made to the invention disclosed in this specification without departing from the scope and spirit of the invention.

What is claimed is:

1. A method for displaying works of art, the method comprising:
a) supplying an artists panel that comprises an identified area for receiving artwork produced by an artist and a specific area for receiving information related to identification of the artist;
b) receiving artwork in the identified area for receiving artwork on the artists panel;
c) framing the artists panel in a frame and framing components;
d) hanging the framed artists panel on a portable device for hanging and displaying a plurality of framed artists panels; and
e) displaying the framed artists panels.

2. The method of claim 1, wherein the identified area for receiving artwork is on one surface of the artists panel and the specific area for receiving information related to identification of the artist is on the opposite surface of the artists panel.

3. The method of claim 1, wherein the specific area for receiving information related to identification of the artist is not within the identified area for receiving artwork.

4. The method of claim 3, wherein the specific area for receiving information related to identification of the artist and the identified area for receiving artwork are on the one surface of the artists panel.

5. The method of claim 1, wherein the artists panel further comprises a bar code or radio frequency identification information.

6. The method of claim 1, wherein the information related to identification of the artist comprises a bar code or radio frequency identification.

7. The method of claim 1, further comprising:
f) digitally photographing the artwork in the identified area for receiving artwork provided on the artists panel;
g) storing a copy of the digitally photographed artwork on a computer system; and
h) providing an access code to the digitally photographed artwork so that the digitally photographed artwork can be accessed and viewed.

8. The method of claim 7, further comprising identifying the artist on the computer system by an identifier selected from the group consisting of an access code, first name, artwork title, and keyword.

9. The method of claim 1, further comprising selling the original artwork or a reproduction of the artwork.

10. The method of claim 1, further comprising selling the artists panel.

11. The method of claim 1, wherein the artist is student.

12. The method of claim 10, wherein framed artists panel is displayed at a school.

13. A method for displaying works of art, the method comprising:
a) supplying a plurality of artists panels comprising a template identifying an area for receiving artwork produced by an artist and a specific area for receiving information related to identification of the artist;
b) artists producing artwork in the template identifying an area for receiving artwork provided on the artists panels;
c) marking the specific area for receiving information with information related to identification of the artist with information identifying the artist that produced the artwork;
d) framing the artists panels in frames and framing components;
e) hanging the framed artists panels on a portable device for hanging and displaying a plurality of framed artists panels; and
f) displaying the plurality of framed artists panels to a viewer or a group of viewers at a location.

14. The method of claim 12, further comprising:
g) digitally photographing the artwork;
h) storing a copy of the digitally photographed artwork on a computer system;
i) assigning an access code to each sheet of paper; and
j) providing an access code to the individual or group of individuals so that the individual or group of individuals can access the digitally photographed artwork that is stored on the computer system.

15. The method of claim 12, further comprising:
k) marketing for sale the framed artists panel;
l) selling at least one framed artists panel;
m) removing any unsold artists panels from the frames and framing components; and
n) reusing the frames and framing components.

16. The method of claim 14, further returning any unsold artists panels to the individual or group of individuals.

17. A method for displaying works of art, the method comprising:
a) supplying a plurality of artists panels to a group of individuals, wherein the artists panels comprise a front surface and a back surface and the front surface comprises (i) an identified area for receiving artwork produced by an individual or a group of individuals and (ii) a specific area for receiving information related to identification of the individual or the group of individuals;
b) an individual or group of individuals producing artwork in the identified area for receiving artwork;
c) marking the specific area for receiving information with information related to identification of the individual or group of individuals with information identifying the individual or individuals that produced the artwork;
d) framing the artists panels in picture frames and framing components;
e) hanging the framed artists panels on a portable device for hanging and displaying the framed artists panels;
f) displaying the plurality of framed artists panels to a viewer or a group of viewers at a location;
g) marketing for sale the framed artists panels to the viewer or group of viewers;
h) removing any unsold artists panels from their frames and framing components; and
i) reusing the frames and framing components.

18. The method of claim 17, further comprising returning any unsold artists panels to the individual or group of individuals.

19. The method of claim 17, wherein the individual and the group of individuals include either preschool, kindergarten, elementary school or middle school students.

20. The method of claim 17, wherein the individual and the group of individuals producing the artwork are elementary school students.
